(19) United States
(12) Patent Application Publication
(10) Pub. No.: US 2004/0251803 A1
(43) Pub. Date: Dec. 16, 2004

(54) Photocatalysis light device

(76) Inventor: D. K. Chiu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/460,358

(22) Filed: Jun. 13, 2003

(51) Int. Cl. H01K 1/34

(52) U.S. Cl. 313/25

(57) ABSTRACT

A photocatalysis light device includes a light bulb which is connected to a connection member and a tube has an end threadedly connected to the connection member with the light bulb located in the tube. TiO2 is coated to an inside and an outside of the tube. The heat of the light bulb activates the TiO2 on the tube to release free radicals to the air.

### FIELD OF THE INVENTION

The present invention relates to a photocatalysis light device having a tube connected to a base of the light bulb and TiO2 is coated on an inside and outside of the tube so that the heat from the light bulb activates the TiO2 to release free radicals.

### BACKGROUND OF THE INVENTION

There are many air cleaning devices developed in the market and most of the air cleaning devices occupy a lot of space and has a high cost so that people cannot own them easily. The air in a closed interior involves bacteria and viruses which are harm to our health and this is crucial especially for kids and seniors. Even if an air cleaning device is used, it usually run by a motor which drives a fan so as to circulate the air through the device. A certain amount of heat is released to the air in the room and this sometime is a problem.

The present invention intends to provide a photocatalysis light device which includes a light bulb and a tube which is mounted to the bulb so as to employs the heat from the bulb to activate the TiO2 coated on the tube to release free radicals to the air. The free radicals transfer the bacteria and virus into harmless to the people.

### SUMMARY OF THE INVENTION

In accordance with one aspect of the present invention, there is provided a photocatalysis light device which comprises a light bulb having a base and a connection member has an inner threaded portion so that the base of the light bulb is connected to the connection member. A tube has an end threadedly connected to the connection member with the light bulb located in the tube. TiO2 is coated to an inside and an outside of the tube.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the photocatalysis light device of the present invention;

FIG. 2 shows the assembly of the photocatalysis light device of the present invention;

FIG. 3 shows holes are defined through a wall of the tube;

FIG. 4 shows another embodiment of the tube of the photocatalysis light device of the present invention;

FIG. 5 shows the tube is a curve tube and two light bulbs are connected to two ends of the tube, and FIG. 6 shows the tube can be a C-shaped tube.

### DETAILED DESCRIPTION OF THE PREFERRED EMBODIMENT

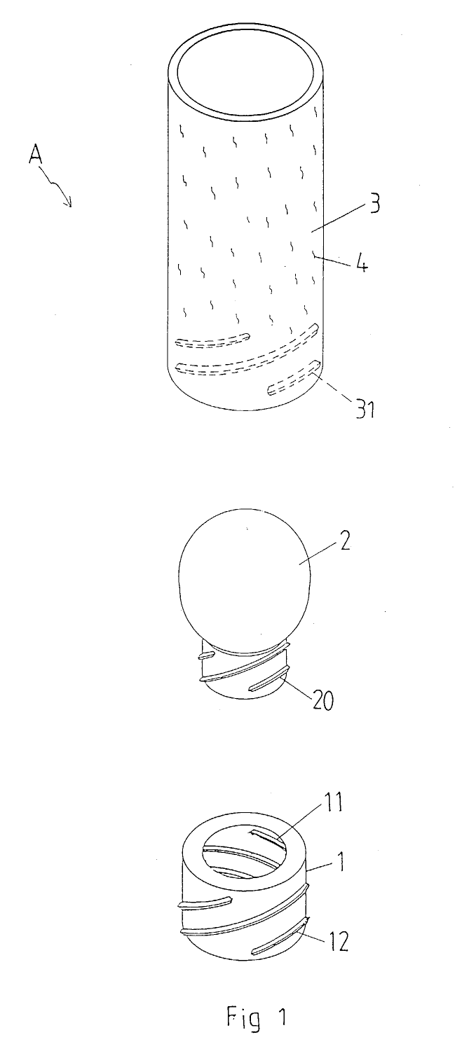

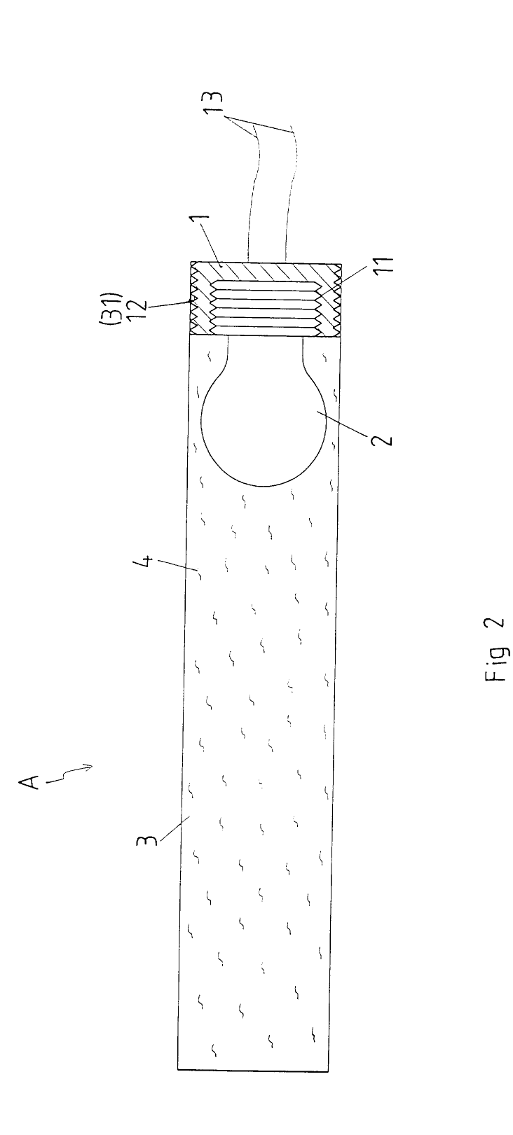

Referring to FIGS. 1 and 2, the photocatalysis light device “A” of the present invention comprises a light bulb 2 having a base 20 and a connection member 1 which has an inner threaded portion 11 and an outer threaded portion 12. The base 20 of the light bulb 2 is threadedly engaged with the inner threaded portion 11 of the connection member 1. A tube 3 made of flexible or hard material has an end with inner threads 3-1 which are threadedly connected to outer threaded portion 12 of the connection member 1 with the light bulb 2 located in the tube 3. TiO2 4 is coated to an inside and an outside of the tube 3. Electric wires 13 are connected to the base 20 of the light bulb 20 such that the light bulb 2 lights in the tube 3 and the heat of the light bulb 2 activates the TiO2 4 so release free radicals to the air. The free radicals improves the quality of the air.

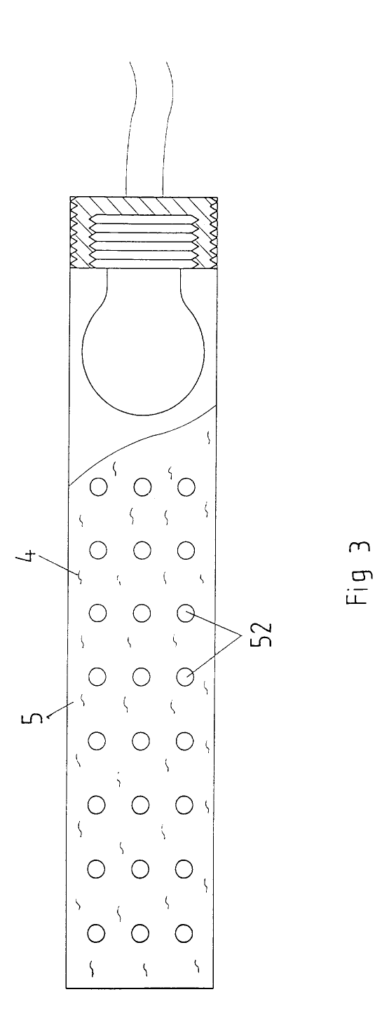

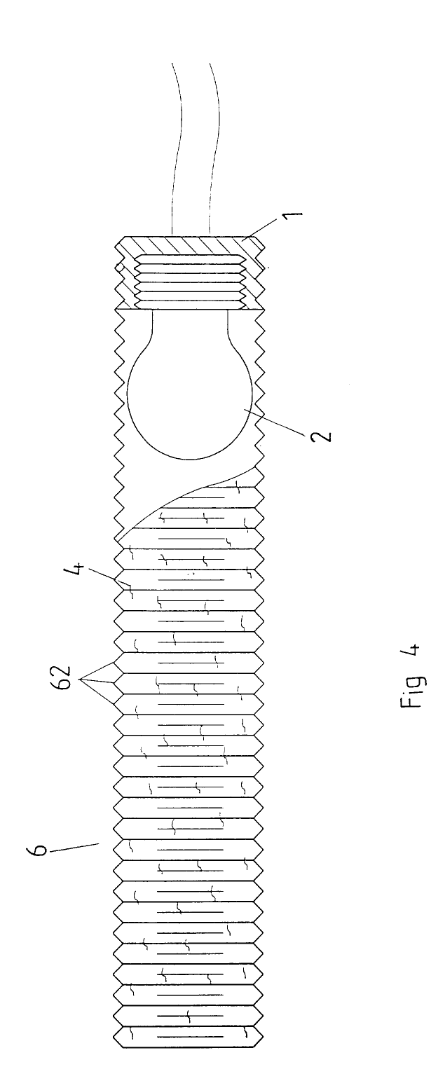

Referring to FIG. 3 which shows another embodiment of the tube 5 which may have a plurality of holes are defined through a wall of the tube 3. FIG. 4 shows yet another embodiment of the tube 6 which is made of flexible material and includes bellows 62 so that the length of the tube 6 can be adjusted.

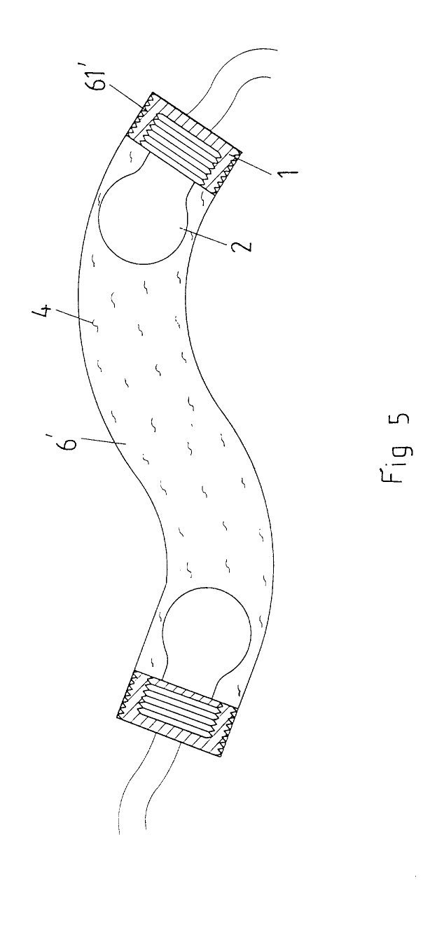

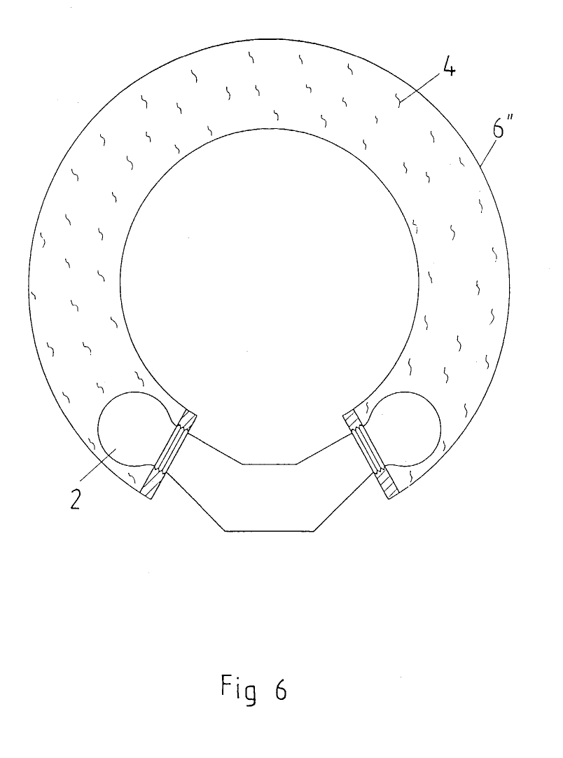

FIG. 5 shows that the tube 6′ is a curve tube and each of the two ends has inner threads 61′ so that two light bulbs 2 are inserted in the two ends of the tube 6′. FIG. 6 shows that the tube 6″ is a C-shaped tube and two light bulbs 2 are respectively inserted into the two ends of the tube 6″.

The length of wave of the light bulb 2 in these embodiments is in a range between 362 nm to 365 nm.

While we have shown and described the embodiment in accordance with the present invention, it should be clear to those skilled in the art that further embodiments may be made without departing from the scope of the present invention.

What is claimed is:

1. A photocatalysis light device comprising:
a light bulb having a base;
a connection member having an inner threaded portion and an outer threaded portion, the base of the light bulb threadedly engaged with the inner threaded portion of the connection member, and
a tube having an end threadedly connected to the connection member with the light bulb located in the tube, TiO2 being coated to an inside and an outside of the tube.

2. The photocatalysis light device as claimed in claim 1, wherein a plurality of holes are defined through a wall of the tube.

3. The photocatalysis light device as claimed in claim 1, wherein a length of wave of the light bulb is in a range between 362 nm to 365 nm.
